(19) United States
(12) Patent Application Publication
(10) Pub. No.: US 2025/0119073 A1
(43) Pub. Date: Apr. 10, 2025

(54) AUTONOMOUS EQUIPMENT FOR GENERATING ELECTRIC ENERGY

(71) Applicants: Pablo César SARTOR, Santa Fe (AR); Julián SARTOR, Santa Fe (AR)

(72) Inventors: Pablo César SARTOR, Santa Fe (AR); Julián SARTOR, Santa Fe (AR)

(21) Appl. No.: 18/820,468

(22) Filed: Aug. 30, 2024

(30) Foreign Application Priority Data
Oct. 5, 2023 (AR) 20230102667

(51) Int. Cl. H02N 2/18

(52) U.S. Cl. CPC H02N 2/181

(57) ABSTRACT

The disclosure relates to equipment that, being autonomous, ecological, and soundproof, includes an asynchronous motor such as that used by motor vehicles, vans, and trucks in general, and, for which purpose it includes a coupling, an electricity generator such as a dynamo, and solar panels, all of which are connected to a corresponding electronic board through which an electronic drive command controller is activated, which regulate the battery charger, a digital panel, and air coolers. The coupling may be hydraulic or elastomeric. The electronic controller is a remote control, while the electronic board includes a digital panel.

A patent of invention is sought on the present invention, which relates to AUTONOMOUS EQUIPMENT FOR GENERATING ELECTRIC ENERGY, it being an ecological, sustainable, and low-maintenance equipment.

More specifically, the present invention refers to autonomous equipment designed to generate electric energy, which comprises using an asynchronous engine such as that used by motor vehicles, vans, and trucks, which includes a hydraulic or elastomeric coupling, a power generator such as a dynamo, and solar panels, all of which are connected to a corresponding electronic board which commands and activates a safety controller, remote control, battery charger, digital panel, and air coolers.

The invention comprises a special design equipment that, due to its particular autonomy, can be installed anywhere, with the capacity to generate 220V and 380V power, and which is characterized in that its batteries can be charged by solar panels or by the same generator (dynamo) which, driven from an electronic control panel, can generate from 15 KVA, this being the KVA generation limit used by the asynchronous motor (due to its size as manufactured).

The invention has been designed for use anywhere under extreme climates since it is completely autonomous, and no daily monitoring and servicing such as recharging fuel, water, oil, filters, belts, etc. is required. Consequently, the inventive generator is ideal for installation in inhospitable places where electricity must be transported, such as public places, fields, and mountains, and where soundproof equipment is required, such as hospitals, buildings, neighborhoods, companies, workshops, and social events.

The inventive generator stands out particularly as a completely autonomous piece of equipment, which does not require fuel, lubricants, etc., and uses a remote controller through which the condition of the equipment can be verified without physically inspecting it, it being completely autonomous and soundproof. Thanks to its asynchronous motor, the generator can be installed in places as needed. Recharging the batteries with solar panels allows to keep them charged, though, however, the generator (dynamo) would also charge the batteries using a DC output charger to keep the equipment running. The durability of the equipment components depends on the previous calculation of consumption (KVA) that higher power equipment will have to generate or install, which is particularly important to avoid overloads, heating in connection tabs, NS key, circuit breaker, wiring, and dynamo. Estimation and control actions before installation of the equipment will depend on the useful life of the equipment, and the KVA size of the equipment will depend on consumption.

Based on the above, it is clear that the present electricity generator is characterized by being a completely autonomous, ecological, and soundproof power generation equipment.

The invention defines a new combination of means intended to achieve a superior result, which is unexpected and surprising even for a person skilled in the particular art. Consequently, in addition to the present novel features, the above object's constructive and functional concept shows a clear inventive activity, which complies with the legal requirements for an invention to be patentable.

### PRIOR ART

As previously indicated, the autonomous electric energy-generating equipment referred to in the present invention has the main advantage that it can be used anywhere under extreme climates for it is totally autonomous and requires no daily maintenance, which provides the important benefit of allowing to use it in places where conventional electricity generators that run on fuel are not convenient.

This advantage arises from the constructive condition of employing a soundproof motor which, as known, comprises a silent alternating current (AC) generator where the electric current is originated by electromagnetic induction of the stator coil magnetic field, through which the rotor twist is produced. Therefore, no mechanical linkage is required as is the case of synchronous motors.

Currently, existing equipment requires daily monitoring since fuel, water, oils, and filters must be recharged, and belts must be replaced. In very few cases equipment can be controlled remotely, and daily service involves excessive costs, as well as fuel and accessories which also cause environmental pollution by generating waste, the same as the combustion engine polluting the environment through gas emission, oil, and fuel spills.

### Brief Description of the Invention—Advantages

The advantages of the electric energy-generating equipment referred to in this invention are many since it is a completely autonomous equipment, which does not require fuel, lubricants, etc. Its remote controller allows to verify the condition of the equipment without physical inspection, as the equipment is completely autonomous and soundproof. Thanks to its asynchronous motor, the equipment can be installed anywhere as required. On the other hand, recharging its batteries with solar panels allows it to keep batteries properly charged, and, otherwise, the generator (dynamo) would also charge the batteries using a DC output charger to keep the equipment running. The durability of the equipment components depends on the previous calculation of KVA consumption to generate or install higher power equipment, which is particularly important to avoid overloads and undesired heating of the connection plugs, NS key, circuit breaker, wiring, dynamo, etc. Said calculation and control before the installation of the equipment will depend on the useful life of the equipment, and the KVA size of the equipment will depend on consumption.

### Inventive Activity

No electric energy-generating equipment currently known proposes, or even suggests, the constructive solution described in the preceding paragraphs, and, for that reason, the proposed invention is not only novel but also involves a clear inventive activity.

### BRIEF DESCRIPTION OF THE DRAWINGS

To specifically show the above advantages, to which users and those skilled in the art can add many more, and to facilitate the understanding of the constructive, constitutive, and functional characteristics of the inventive equipment, below is a preferred example of embodiment, which is illustrated, schematically and without a specific scale, in the attached sheets. It is made particularly clear that, as an exemplary embodiment of the invention, said exemplary embodiment is not a limitation of the scope of protection of the present invention but is only intended to explain and illustrate the basic concept on which the same is based.

FIG. 1 is a functional diagram showing the means that constitute the equipment of this invention.

FIG. 2 is also a basic functional diagram of the same autonomous generator of the previous Figure.

FIG. 3 is also a diagram showing the circuit that implements the operation of the electricity-generating equipment of this invention.

It is to be noted that, in all figures, the same reference numbers and letters refer to the same or equivalent parts or elements constituting the assembly, according to the example chosen for the present description of the inventive equipment.

### Detailed Description of a Preferred Example

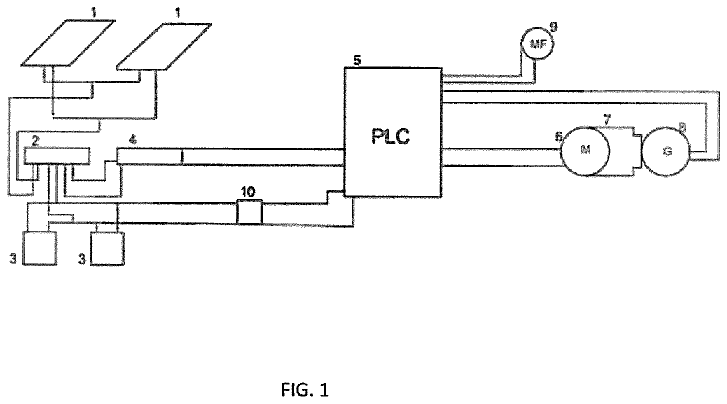

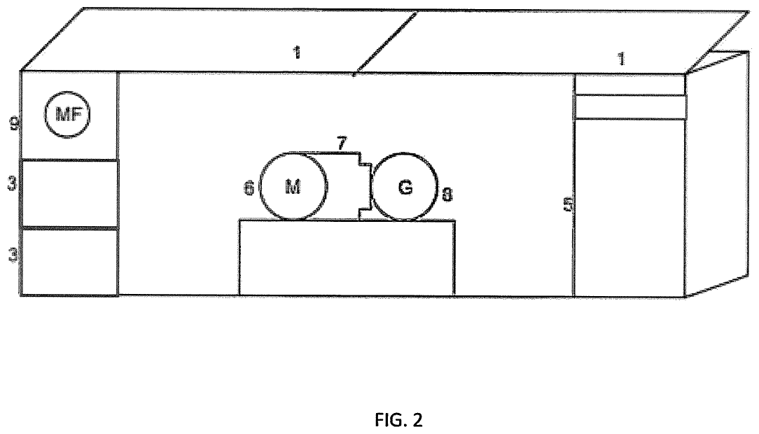

FIGS. 1 and 2 show the autonomous equipment for generating electric energy of the present invention, being a completely autonomous, ecological, and soundproof equipment, which comprises an asynchronous motor (6) that is started by a coupling (7) to the generator (dynamo) (8). By activating an electronic disconnector, 220V, and 380V power is generated. Upon receiving the consumption demand, the asynchronous motor (6) accelerates to secure the necessary KVA delivered by the generator (8), to which effect the asynchronous motor (automotive, pick up, truck) and (dynamo) suitable for each application is determined.

The equipment has a system of electronic load control (consumption demand) and (5) battery charge controls (3) that receive energy from the solar panels (1), or from the generator itself (8) to maintain an asynchronous motor (6) running for an indefinite period. The equipment also comprises a motor rpm control, anchoring systems, safe refrigerated and watertight cabinet, and labeling (alerts, maintenance, security, protections) remote control equipment via Wi-Fi (cameras, sensors temperatures, movements, etc.).

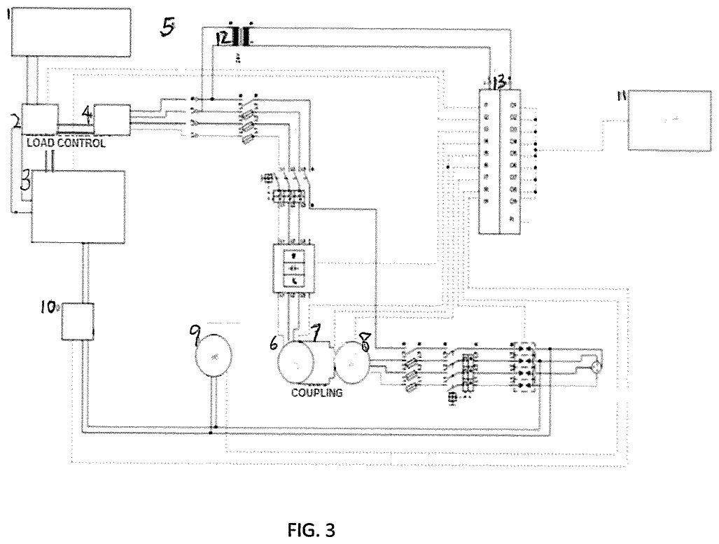

The operating scheme of the autonomous equipment for generating electric energy of this invention can now be understood based on the electronic diagram shown in FIG. 3.

The use of solar panels (1) is shown, which, as already known, are responsible for generating direct current electricity by capturing sunlight. Said direct current is taken by the said charge controller (2) from where the charge of batteries (3) is generated.

The batteries (3) receive that charge and divert the direct current to the controller (2) so that it captures the current and takes it to the inverter (4), which function is to transform the energy from direct current to alternating current, three conductor lines being thus obtained (L1, L2.L3.380v).

Having the three phases plus a neutral located in the control box or panel (5), an NS-type key is entered which will be responsible for activating the engine power electric circuit.

A circuit breaker is included to protect the circuit and the electric and electronic devices, together with a speed variator that will be responsible for decreasing or increasing the motor speed (9) when available and comprises internal thermal protection for the motor and circuit against electric overload. Finally, the asynchronous motor (6) will be connected to the output of the speed variator.

The control system operates through a PLC (5). The display and communication that derives to the PLC (13) will originate through an HMI touch screen (11) from which the start order, stop order, equipment control, current consumption, etc., will be given.

A Wi-Fi connection will be available to control the equipment remotely.

When the HMI (11) is turned on, taking a 24v continuous type voltage, the following battery charge control (2) is displayed, which passes through the PLC giving the signal that batteries are charged, and the start-up of the electric motor (6) will be enabled. In turn, the load control coming from the solar panels (12) will be displayed, and when the start order is given from HMI (11), the PLC will command the drive to start the 50 HZ electric motor (6) at 1500 rpm. This is coupled to a hydraulic coupling (7) which will be responsible for moving the dynamo generator (8).

When the electric motor is turned on, the generator begins to rotate, generating voltage. There are 3 output lines and a neutral, which will be connected to an NS-type contactor, a circuit breaker, and surge limiters, and voltage is directed to the respective socket.

The electric motor (6) and the generator (8) will be rotating at 1505 rpm as long as energy is not being consumed from the generator. When consumption starts at the generator output, the rpm rate will decrease, and, as a result, the rpm revolution counter sensor (16) will be set at 1505 rpm with a maximum of 1510 rpm and a minimum of 1500 rpm. If that rpm decrease is due to consumption from the generator, the PLC will take that information and it will command the variator to increase the frequency up to 1505 rpm, otherwise, it will command a frequency decrease.

### THE FOLLOWING IS DISPLAYED WITHIN THE HMI

1: battery charge control
2: battery charge and level
3: Motor start, stop, and consumption (6)
4: electric motor temperature (6)
5: rpm sensor and revolution counter, which will take the RPM from the generator shaft.
6: generator temperature (8)
7: overload limitation and protection, consumption of each generator output line
8: room temperature control, the air coolers start and stop control (9)
9: battery charger (10) (when the batteries decrease below 50% the charger will be commanded to begin charging the batteries).

An optional Wi-Fi connection will be able to control and start the equipment remotely.

1. An autonomous equipment for generating electric energy, said equipment being autonomous, ecological, and soundproof, wherein said equipment comprises an asynchronous motor such as that used by motor vehicles, vans and trucks in general, and further comprises a coupling, a power generator such as a dynamo, and solar panels, all of which are connected to a corresponding electronic board which commands and activates an electronic control which regulates a battery charger, digital panel and air coolers.

2. An autonomous equipment for generating electric energy, according to claim 1, wherein the coupling is a hydraulic coupling.

3. An autonomous equipment for generating electric energy, according to claim 1, wherein the coupling is elastomeric.

4. An autonomous equipment for generating electric energy, according to claim 1, wherein the electronic controller is a remote control.

5. An autonomous equipment for generating electric energy, according to claim 1, wherein the electronic board includes a digital panel.
